(19) United States
(12) Patent Application Publication
(10) Pub. No.: US 2006/0188165 A1
(43) Pub. Date: Aug. 24, 2006

(54) Spatial prediction based intra-coding

(76) Inventor: Marta Karczewicz, Irving, TX (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/408,908

(22) Filed: Apr. 21, 2006

Related U.S. Application Data
(63) Continuation of application No. 10/171,467, filed on Jun. 12, 2002.

(51) Int. Cl. G06K 9/36

(52) U.S. Cl. 382/238

(57) ABSTRACT

A method and device for coding a digital image using intra-mode block prediction, wherein the prediction mode of a current block is obtained from the prediction mode of the neighboring blocks. Using the property that it is possible to obtain an ordered list of prediction modes for one combination of prediction modes of the neighboring blocks as a function of the prediction modes for another combination, the size of the prediction table to be used in the encoding and decoding stages can be reduced. Furthermore, in the case of JVT coder, some of the prediction modes can be grouped together and the prediction modes can be relabeled in order to reduce the number of prediction modes.

### FIELD OF THE INVENTION

The present invention relates generally to image coding and, more particularly, to coding blocks of video frames.

### BACKGROUND OF THE INVENTION

A digital image, such as a video image, a TV image, a still image or an image generated by a video recorder or a computer, consists of pixels arranged in horizontal and vertical lines. The number of pixels in a single image is typically in the tens of thousands. Each pixel typically contains luminance and chrominance information. Without compression, the quantity of information to be conveyed from an image encoder to an image decoder is so enormous that it renders real-time image transmission impossible. To reduce the amount of information to be transmitted, a number of different compression methods, such as JPEG, MPEG and H.263 standards, have been developed. In a typical video encoder, the frame of the original video sequence is partitioned into rectangular regions or blocks, which are encoded in Intra-mode (I-mode) or Inter-mode (P-mode). The blocks are coded independently using some kind of transform coding, such as DCT coding. However, pure block-based coding only reduces the inter-pixel correlation within a particular block, without considering the inter-block correlation of pixels, and it still produces high bit-rates for transmission. Current digital image coding standards also exploit certain methods that reduce the correlation of pixel values between blocks.

In general, blocks encoded in P-mode are predicted from one of the previously coded and transmitted frames. The prediction information of a block is represented by a two-dimensional (2D) motion vector. For the blocks encoded in I-mode, the predicted block is formed using spatial prediction from already encoded neighboring blocks within the same frame. The prediction error, i.e., the difference between the block being encoded and the predicted block is represented as a set of weighted basis functions of some discrete transform. The transform is typically performed on an 8×8 or 4×4 block basis. The weights—transform coefficients—are subsequently quantized. Quantization introduces loss of information and, therefore, quantized coefficients have lower precision than the originals.

Quantized transform coefficients, together with motion vectors and some control information, form a complete coded sequence representation and are referred to as syntax elements. Prior to transmission from the encoder to the decoder, all syntax elements are entropy coded so as to further reduce the number of bits needed for their representation.

In the decoder, the block in the current frame is obtained by first constructing its prediction in the same manner as in the encoder and by adding to the prediction the compressed prediction error. The compressed prediction error is found by weighting the transform basis functions using the quantized coefficients. The difference between the reconstructed frame and the original frame is called reconstruction error.

The compression ratio, i.e., the ratio of the number of bits used to represent the original and compressed sequences, both in case of I- and P-blocks, is controlled by adjusting the value of the quantization parameter that is used to quantize transform coefficients. The compression ratio also depends on the employed method of entropy coding

An example of spatial prediction used in a JVT coder is described as follows. In order to perform the spatial prediction, the JVT coder offers 9 modes for prediction of 4×4 blocks, including DC prediction (Mode 0) and 8 directional modes, labeled 1 through 7, as shown in FIG. 1. The prediction process is illustrated in FIG. 2. As shown in FIG. 2, the pixels from a to p are to be encoded, and pixels A to R from neighboring blocks that have already been encoded are used for prediction. If, for example, Mode 1 is selected, then pixels a, e, i and m are predicted by setting them equal to pixel A, and pixels b, f, j and n are predicted by setting them equal to pixel B, etc. Similarly, if Mode 2 is selected, pixels a, b, c and d are predicted by setting them equal to pixel 1, and pixels e, f, g and h are predicted by setting them equal to pixel J, etc. Thus, Mode 1 is a predictor in the vertical direction; and Mode 2 is a predictor in the horizontal direction. These modes are described in document VCEG-N54, published by ITU—Telecommunication Standardization Sector of Video Coding Expert Group (VCEG) in September 2001, and in document JVT-B118r4, published by the Joint Video Team of ISO/IEC MPEG and ITU-T VCEG in February 2002.

Mode 0: DC Prediction

Generally all samples are predicted by (A+B+C+D+I+J+K+L+4)>>3. If four of the samples are outside the picture, the average of the remaining four is used for prediction. If all eight samples are outside the picture the prediction for all samples in the block is 128. A block may therefore always be predicted in this mode

Mode 1: Vertical Prediction

If A, B, C, D are inside the picture, then
a, e. i, m are predicted by A,
b, f, j, n are predicted by B,
c, g. k, o are predicted by C,
d, h. l, p are predicted by D.

Mode 2: Horizontal Prediction

If E, F, G, H are inside the picture, then
a, b, c, d are predicted by E,
e, f, g, h are predicted by F,
i, j, k, l are predicted by G,
m, n, o, p are predicted by H.

Mode 3: Diagonal Down/Right Prediction

This mode is used only if all A, B, C, D, I, J, K, L, Q are inside the picture. This is a “diagonal” prediction.

| | |
|---|---|
| m is predicted by | (J + 2K + L + 2) >> 2 |
| i, n are predicted by | (I + 2J + K + 2) >> 2 |
| e, j, o are predicted by | (Q + 2I + J + 2) >> 2 |
| a, f, k, p are predicted by | (A + 2Q + I + 2) >> 2 |
| b, g, l are predicted by | (Q + 2A + B + 2) >> 2 |
| c, h are predicted by | (A + 2B + C + 2) >> 2 |
| d is predicted by | (B + 2C + D + 2) >> 2 |

Mode 4: Diagonal Down/Left Prediction

This mode is used only if all A, B, C, D, I, J, K, L, Q are inside the picture. This is a “diagonal” prediction.

| | |
|---|---|
| a is predicted by | (A + 2B + C + I + 2J + K + 4) >> 3 |
| b, e are predicted by | (B + 2C + D + J + 2K + L + 4) >> 3 |
| c, f, i are predicted by | (C + 2D + E + K + 2L + M + 4) >> 3 |
| d, g, j, m are predicted by | (D + 2E + F + L + 2M + N + 4) >> 3 |
| h, k, n are predicted | (E + 2F + G + M + 2N + O + 4) >> 3 |
| l, o are predicted by | (F + 2G + H + N + 2O + P + 4) >> 3 |
| p is predicted by | (G + H + O + P + 2) >> 3 |

Mode 5: Vertical-Left Prediction

This mode is used only if all A, B, C, D, I, J, K, L, Q are inside the picture. This is a “diagonal” prediction.

| | |
|---|---|
| a, j are predicted by | (Q + A + 1) >> 1 |
| b, k are predicted by | (A + B + 1) >> 1 |
| c, l are predicted by | (B + C + 1) >> 1 |
| d is predicted by | (C + D + 1 >> 1 |
| e, n are predicted by | (I + 2Q + A + 2) >> 2 |
| f, o are predicted by | (Q + 2A + B + 2) >> 2 |
| g, p are predicted by | (A + 2B + C + 2) >> 2 |
| h is predicted by | (B + 2C + D + 2) >> 2 |
| i is predicted by | (Q + 2I + J + 2) >> 2 |
| m is predicted by | (I + 2J + K + 2) >> 2 |

Mode 6: Vertical-Right Prediction

This mode is used only if all A, B, C, D, I, J, K, L, Q are inside the picture. This is a “diagonal” prediction.

| | |
|---|---|
| a is predicted by | (2A + 2B + J + 2K + L + 4) >> 3 |
| b, i are predicted by | (B + C + 1) >> 1 |
| c, j are predicted by | (C + D + 1) >> 1 |
| d, k are predicted by | (D + E + 1) >> 1 |
| l is predicted by | (E + F + 1) >> 1 |
| e is predicted by | (A + 2B + C + K + 2L + M + 4) >> 3 |
| f, m are predicted by | (B + 2C + D + 2) >> 2 |
| g, n are predicted by | (C + 2D + E + 2) >> 2 |
| h, o are predicted by | (D + 2E + F + 2) >> 2 |
| p is predicted by | (E + 2F + G + 2) >> 2 |

Mode 7: Horizontal-Up Prediction

This mode is used only if all A, B, C, D, I, J, K, L, Q are inside the picture. This is a “diagonal” prediction.

| | |
|---|---|
| a is predicted by | (B + 2C + D + 2I + 2J + 4) >> 3 |
| b is predicted by | (C + 2D + E + I + 2J + K + 4) >> 3 |
| c, e are predicted by | (D + 2E F + 2J + 2K + 4) >> 3 |
| d, f are predicted by | (E + 2F + G + J + 2K + L + 4) >> 3 |
| g, i are predicted by | (F + 2G + H + 2K + 2L + 4) >> 3 |
| h, j are predicted by | (G + 3H + K + 3L + 4) >> 3 |
| l, n are predicted by | (L + 2M + N + 2) >> 3 |
| k, m are predicted by | (G + H + L + M + 2) >> 2 |
| o is predicted by | (M + N + 1) >> 1 |
| p is predicted by | (M + 2N + O + 2) >> 2 |

Mode 8: Horizontal-Down Prediction

This mode is used only if all A, B, C, D, I, J, K, L, Q are inside the picture. This is a “diagonal” prediction.

| | |
|---|---|
| a, g are predicted by | (Q + I + 1) >> 1 |
| b, h are predicted by | (I + 2Q + A + 2) >> 2 |
| c is predicted by | (Q + 2A + B + 2) >> 2 |
| d is predicted by | (A + 2B + C + 2) >> 2 |
| e, k are predicted by | (I + J + 1) >> 1 |
| f, l are predicted by | (X + 2I + J + 2) >> 2 |
| i, o are predicted by | (J + K + 1) >> 1 |
| j, p are predicted by | (I + 2J + K + 2) >> 2 |
| m is predicted by | (K + L + 1) >> 1 |
| n is predicted by | (J + 2K + L + 2) >> 2 |

Since each block must have a prediction mode assigned and transmitted to the decoder, this would require a considerable number of bits if coded directly. In order to reduce the amount of information to be transmitted, the correlation of the prediction modes of adjacent blocks can be used. For example, Vahteri et al. (WO 01/54416 A1, “A Method for Encoding Images and An Image Coder”, hereafter referred to as Vahteri) discloses a block-based coding method wherein directionality information of the image within the blocks are used to classify a plurality of spatial prediction modes. The spatial prediction mode of a block is determined by the spatial prediction mode of at least one neighboring block. For example, when the prediction modes of neighboring, already-coded blocks U and L are known, an ordering of the most probable prediction mode, the next most probable prediction mode, etc., for block C is given (FIG. 3).

The ordering of modes is specified for each combination of prediction modes of U and L. This order can be specified as a list of prediction modes for block C ordered from the most to the least probable one. The ordered list used in the JVT coder, as disclosed in VCEG-N54, is given below:

TABLE I

Prediction mode as a function of ordering signalled in the
bitstream

| | | | | | |
|---|---|---|---|---|---|
| L/U | outside | 0 | 1 | 2 | 3 |
| outside | -------- | 0-------- | 01------- | 10------- | --------- |
| 0 | 02------- | 021648573 | 125630487 | 021876543 | 021358647 |
| 1 | --------- | 102654387 | 162530487 | 120657483 | 102536487 |
| 2 | 20------- | 280174365 | 217683504 | 287106435 | 281035764 |
| 3 | --------- | 201385476 | 125368470 | 208137546 | 325814670 |
| 4 | --------- | 201467835 | 162045873 | 204178635 | 420615837 |
| 5 | --------- | 015263847 | 152638407 | 201584673 | 531286407 |
| 6 | --------- | 016247583 | 160245738 | 206147853 | 160245837 |
| 7 | --------- | 270148635 | 217608543 | 278105463 | 270154863 |
| 8 | --------- | 280173456 | 127834560 | 287104365 | 283510764 |
| L/U | 4 | 5 | 6 | 7 | 8 |
| outside | -------- | --------- | --------- | --------- | --------- |
| 0 | 206147583 | 512368047 | 162054378 | 204761853 | 208134657 |
| 1 | 162045378 | 156320487 | 165423078 | 612047583 | 120685734 |
| 2 | 287640153 | 215368740 | 216748530 | 278016435 | 287103654 |
| 3 | 421068357 | 531268470 | 216584307 | 240831765 | 832510476 |
| 4 | 426015783 | 162458037 | 641205783 | 427061853 | 204851763 |
| 5 | 125063478 | 513620847 | 165230487 | 210856743 | 210853647 |
| 6 | 640127538 | 165204378 | 614027538 | 264170583 | 216084573 |
| 7 | 274601853 | 271650834 | 274615083 | 274086153 | 278406153 |
| 8 | 287461350 | 251368407 | 216847350 | 287410365 | 283074165 |

Here, an example of the prediction modes for the block C, as specified in the JVT coder, is given when the prediction mode for both U and L is 2. The string (2, 8, 7, 1, 0, 6, 4, 3, 5) indicates that mode 2 is also the most probable mode for block C. Mode 8 is the next most probable mode, etc. To the decoder the information will be transmitted indicating that the nth most probable mode will be used for block C. The ordering of the modes for block C can also be specified by listing the rank for each mode: the higher the rank, the less probable the prediction method. For the above example, the rank list would be (5, 4, 1, 8, 7, 9, 6, 3, 2). When the modes (0, 1, 2, 3, 4, 5, 6, 7, 8) are related to the rank list (5, 4, 1, 8, 7, 9, 6, 3, 2), we can tell that Mode 0 has a rank 5, Mode 1 has a rank 4, etc.

For more efficient coding, information on intra prediction of two 4×4 blocks can be coded in one codeword.

The above-mentioned method has one major drawback—the memory required to keep ordering of prediction modes for block C given prediction modes of blocks U and L is demanding. In the JVT coder, because 9 modes are used for prediction, there are 9×9 possible combinations of modes for blocks U and L. For each combination, an ordering of 9 possible modes has to be specified. That means that 9×9×9 bytes (here it is assumed that one number requires one byte) are needed to specify the ordering of prediction modes. In addition, more memory may be required to specify the special cases—for example, if one or both blocks U and L are not available.

Thus, it is advantageous and desirable to provide a method and device for coding a digital image wherein the memory requirements are reduced while the loss in coding efficiency is minimal.

### SUMMARY OF THE INVENTION

It is a primary objective of the present invention to reduce the prediction table to be used for the encoding and decoding stages in an image coding system. This objective can be achieved by eliminating the prediction elements in the prediction table using the symmetry of the table.

Thus, according to the first aspect of the present invention, there is provided a method of coding an image comprising a plurality of image blocks using a plurality of spatial prediction modes for intra-mode block prediction, wherein the spatial prediction modes are classified based on directionality information of the image within the image blocks so as to allow the spatial prediction mode of a block (C) to be determined based on the spatial prediction mode of at least one neighboring block of the block (C). The method is characterized by

mapping the spatial prediction mode of the neighboring block for providing a complementary prediction mode of the neighboring block when needed, by

determining a complementary prediction mode of the block (C) based on the complementary prediction mode of the neighboring block, and by

mapping the complementary prediction mode of the block (C) for obtaining the spatial prediction mode of the block (C).

Advantageously, said at least one neighboring block of the block (C) comprises a first block (U) located on the top of the block (C), and a second block (L) located on the left of the block (C).

Advantageously, the mapping of the spatial prediction mode of the neighboring block is carried out in a decoding stage, and the neighboring block is received prior to the block (C).

Advantageously, when said coding comprises an encoding stage and a decoding stage, and the encoding stage is used to provide prediction parameters indicative of the image blocks to the decoding stage so as to allow the decoding stage to reconstruct the image based on the predication parameters, the method is further characterized in that the mapping of the spatial prediction mode of the neighboring block is carried out in the decoding stage.

Advantageously, the encoding stage comprises a decoding step, and the method is further characterized in that the mapping of the spatial prediction mode of the neighboring block is also carried out in the decoding step in the encoding stage.

According to the second aspect of the present invention, there is provided a decoding device for decoding an image comprising a plurality of blocks using a plurality of spatial prediction modes for intra-mode block prediction, wherein the spatial prediction modes are classified based on directionality information of the image within the image blocks so as to allow the spatial prediction mode of a current block (C) to be determined based on the spatial prediction mode of at least one neighboring block of the current block (C). The device is characterized by:

means for mapping the spatial prediction mode of the neighboring block for providing a complementary prediction mode of the neighboring block when needed so as to allow a complementary prediction mode of the current block to be determined based on the complementary prediction mode of the neighboring block, and by

means for mapping the complementary prediction mode of the current block for obtaining the spatial prediction mode of the current block.

Advantageously, the mapping of the spatial prediction mode of the neighboring block and the mapping of the complementary prediction mode of the current block are carried out by a mirroring function.

According to the third aspect of the present invention, there is provided an encoding device for coding an image comprising a plurality of blocks using a plurality of spatial prediction modes for intra-mode block prediction, wherein the encoding device provides prediction parameters indicative of the spatial prediction modes to a decoding device so as to allow the decoding device to reconstruct the image based on the prediction parameters, and wherein the spatial prediction modes are classified based on directionality information of the image within the image blocks so as to allow the spatial prediction mode of a current block (C) to be determined based on the spatial prediction mode of at least one neighboring block of the current block (C). The encoding device is characterized by

means for determining the spatial prediction mode of said at least one neighboring block, by

means for mapping the spatial prediction mode of the neighboring block for providing a complementary prediction mode of the neighboring block when needed so as to allow a complementary prediction mode of the current block (C) to be determined based on the complementary prediction mode of the neighboring block, and by

means for mapping the complementary prediction mode of the current block (C) for obtaining the spatial prediction mode of the current block (C).

According to the fourth aspect of the present invention, there is provided an image coding system for coding an image comprising a plurality of blocks using a plurality of spatial prediction modes for intra-mode block prediction, said image coding system comprising an encoding device and a decoding device, wherein the encoding device provides prediction parameters indicative of the spatial prediction modes to a decoding device so as to allow the decoding device to reconstruct the image based on the prediction parameters, and wherein the spatial prediction modes are classified based on directionality information of the image within the image blocks so as to allow the spatial prediction mode of a current block (C) to be determined based on the spatial prediction mode of at least one neighboring block of the current block (C). The system is characterized by

means for mapping the spatial prediction mode of the neighboring block for providing a complementary prediction mode of the neighboring block when needed so as to allow a complementary prediction mode of the current block (C) to be determined based on the complementary prediction mode of the neighboring block, and by

means for mapping the complementary prediction mode of the current block (C) for obtaining the spatial prediction mode of the current block (C).

Advantageously, the mapping means are disposed in the decoding device.

Advantageously, the mapping means are also disposed in the encoding device.

According to the fifth aspect of the invention, there is provided a computer program for use in a decoding stage of a coding system for coding an image comprising a plurality of image blocks, said coding system using a plurality of spatial prediction modes for intra-mode block prediction, wherein the spatial prediction modes are classified based on directionality information of the digital image within the image blocks so as to allow the spatial prediction mode of a block (C) to be determined based on the spatial prediction mode of at least one neighboring block of the block (C). The computer program is characterized by

a computer code for mapping the spatial prediction mode of the neighboring block for providing a complementary prediction mode of the neighboring block when needed so as to allow a complementary prediction mode of the block (C) to be determined from the complementary prediction mode of the neighboring block; and

a computer code for mapping the complementary prediction mode of the block (C) for obtaining the spatial prediction mode of the block (C).

According to the sixth aspect of the present invention, there is provided a method of generating a prediction table for use in a decoding stage of a coding system for coding an image comprising a plurality of blocks using a plurality of spatial prediction modes based on intra-mode block prediction, so as to allow the spatial prediction mode of a current block to be determined from the spatial prediction mode of at least one neighboring block of the current block, and the predictable table comprises prediction elements for determining the spatial prediction modes. The method is characterized by:

sorting the prediction elements into a first group of elements and a second group of elements, such that each of the elements in the second group can be determined from a corresponding element in the first group by mapping; and

conveying only the elements in the first group to the decoding stage so as to allow the spatial prediction mode of said at least neighboring block to be determined from the elements of the first group.

### BRIEF DESCRIPTION OF THE DRAWINGS

FIG. 1 is a schematic representation illustrating 8 directional modes that are used as spatial prediction modes.

FIG. 2 is a schematic representation illustrating the pixels that are used for the prediction of a current 4×4 block of pixels.

FIG. 3 is a schematic representation illustrating two neighboring blocks being used for the prediction of a current block.

FIG. 4a is a schematic representation illustrating the spatial prediction mode of two neighboring blocks used for the prediction of a current block.

FIG. 4b is a schematic representation illustrating the spatial prediction mode of two neighboring blocks having a mirrored relationship with those of FIG. 4a.

FIG. 5a is a schematic representation illustrating another spatial prediction mode pair.

FIG. 5b is a schematic representation illustrating the mirrored mode pair.

FIG. 6 is a flow-charting illustrating the method of spatial prediction, according to the present invention.

FIG. 7 is a block diagram illustrating a digital image block transfer system for implementing the method according to the present invention.

FIG. 8 is a block diagram illustrating a portable video telecommunications device implementing the method according to the present invention.

### BEST MODE TO CARRY OUT THE INVENTION

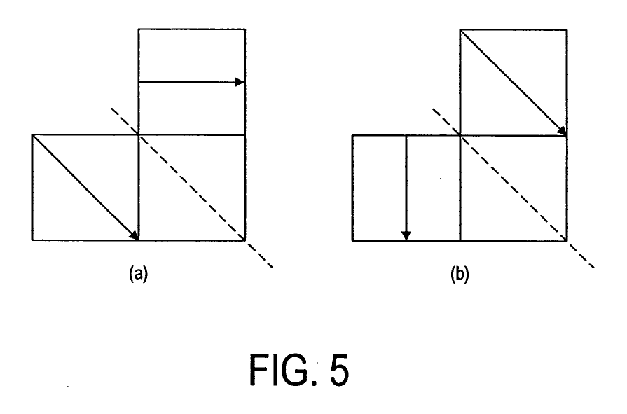

The present invention utilizes the property that it should be possible to obtain an ordered list of prediction modes for one combination of prediction modes of neighboring blocks as a function of prediction modes for another combination. For illustration purposes, prediction modes of two neighboring blocks U and L, as shown in FIG. 4a, are used to infer the prediction of the current block C. It is noted that a combination of prediction modes in FIG. 4a can be obtained by flipping diagonally the prediction modes, as shown in FIG. 4b. Accordingly, the nth most probable prediction mode for block C, when the combination of modes in FIG. 4a is used, should be the same as the “flipped diagonally”, nth-most-probable prediction mode for the combination of modes in FIG. 4b. Thus, if the neighboring blocks U and L have the modes “vertical” and “vertical”, the prediction mode of the current block C is most probably “vertical” (FIG. 4b). Consequently, when these blocks are “flipped” or mirrored against the diagonal (“down/right”), we know that from “horizontal” and “horizontal” we should get “horizontal” for the current block (FIG. 4a). Similarly, if the neighboring blocks U and L are of Modes 2 and 3, as shown in FIG. 5a, then the flipped blocks U and L will be of Modes 3 and 1, as shown in FIG. 5b.

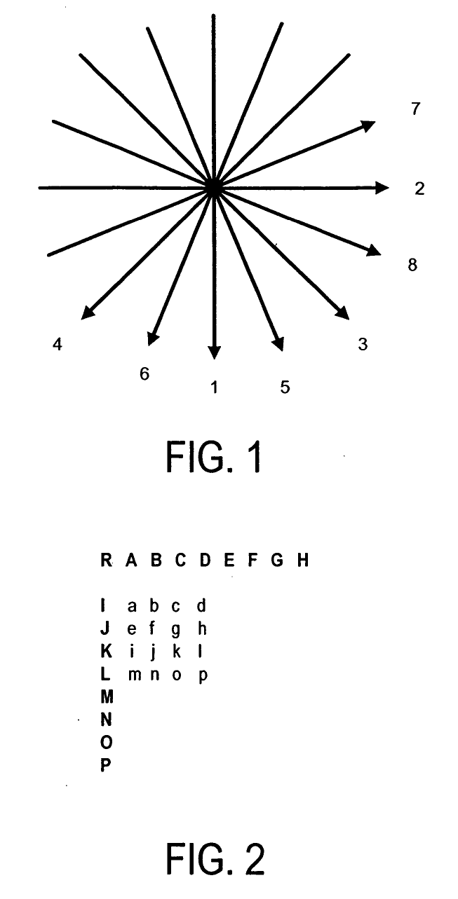

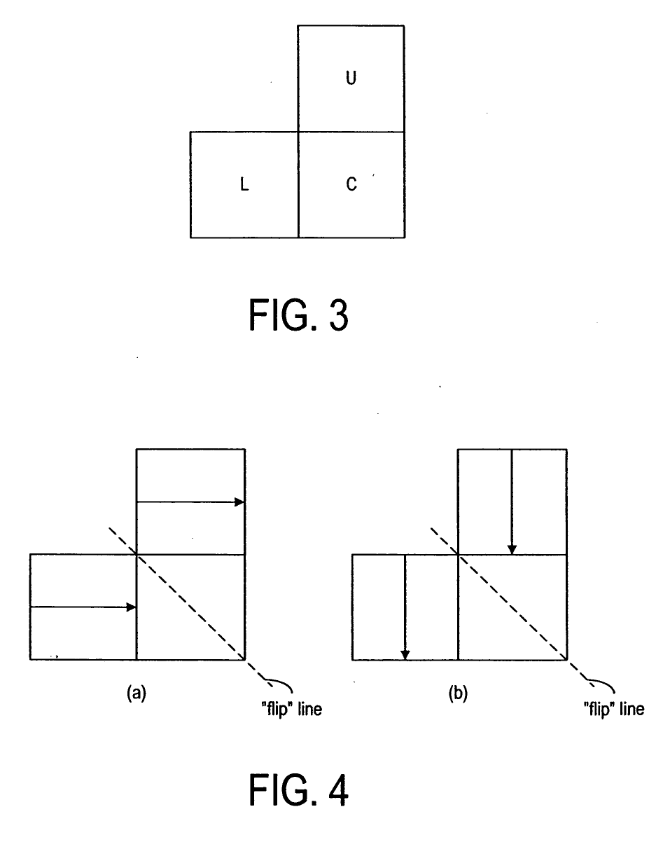

To further illustrate this example, let us define the function ƒ which maps the prediction direction i into j, j=ƒ(i) as follows. Each prediction mode i is assigned a prediction mode j obtained by mirroring it about the diagonal line going from upper left corner of the block to lower right corner of the block. For the prediction modes in FIG. 1, the resulting assignment is summarized in Table II.

TABLE II

| i | j |
|---|---|
| 0 | 0 |
| 1 | 2 |
| 2 | 1 |
| 3 | 3 |
| 4 | 4 |
| 5 | 8 |
| 6 | 7 |
| 7 | 6 |
| 8 | 5 |

When the function is defined as above, the ordered list of prediction modes for the combination of modes (k, l) can be determined based on the ordered list for combination (i, j) such that i=ƒ(l) and j=ƒ(k), i.e., if the prediction mode p is the nth most probable mode for the combination (i, j), the nth mode for the combination (k, l) is equal to ƒ(p). As an example let us consider the combination of modes (1,1 ) to which the ordered list of modes for block C is assigned: (1, 6, 2, 5, 3, 0, 4, 8, 7). It should be possible to obtain the ordered list of the prediction modes for combination (2,2) from this ordered list by mapping using the function f: (2, 7, 1, 8, 3, 0, 4, 6, 5). Similarly, the ordered list of the prediction modes for combination (2,3) is (2, 0, 8, 1, 3, 7, 5, 4, 6) and the ordered list of modes ƒ(2,3)=(3,1) is ƒ(2, 0, 8, 1, 3, 7, 5, 4, 6)=(1, 0, 5, 2, 3, 6, 8, 4, 7). It should be noted that the ordered list of prediction modes for (k,l) can be substantially symmetrical to that for (i,j). Thus, the mapping function ƒ can be described as a mirroring function.

According to the present invention, the mode pairs can be trained together in the cases where they can be obtained from each other by mapping or mirroring. Consequently, the prediction table will be shorter because almost half of the mode pairs can be obtained by flipping from the diagonal mirror element. Thus, the present invention reduces the size of the prediction table, speeding up processing in the encoder and decoder and saving memory, which is especially important in small mobile devices. The reduced prediction table, according to the present invention, is shown in TABLE III.

TABLE III
Reduced Prediction Table

| | | | | | |
|---|---|---|---|---|---|
| L/U | outside | 0 | 1 | 2 | 3 |
| outside | -------- | 0-------- | 01------- | 10------- | --------- |
| 0 | 02------- | 024167835 | 150642387 | 027486135 | 013245867 |
| 1 | --------- | | 150643278 | 021468735 | 105436287 |
| 2 | 20------- | | 124086573 | | 283407156 |
| 3 | --------- | | | | 385240167 |
| 4 | --------- | | | | |
| 5 | --------- | | | | |
| 6 | --------- | | | | |
| 7 | --------- | | | | |
| 8 | --------- | | | | |
| L/U | 4 | 5 | 6 | 7 | 8 |
| outside | --------- | --------- | --------- | --------- | --------- |
| 0 | 012465738 | 150346287 | 160452387 | 024716835 | 028413765 |
| 1 | 104562378 | 156403287 | 165403278 | 014652738 | 014256837 |
| 2 | 240781635 | 214835076 | 241086735 | 207483165 | 280473156 |
| 3 | 413205876 | 531480267 | 146530287 | 247308516 | 832045176 |
| 4 | 420671835 | 145602387 | 461027538 | 407261835 | 248073165 |
| 5 | | 513406287 | 165402387 | 240158376 | 082354167 |
| 6 | | 614503287 | 614057328 | 042617385 | 024681357 |
| 7 | | 427016385 | 426701835 | | 284703615 |
| 8 | | 328514067 | 248361075 | 248703651 | |

In TABLE III for some combinations (U, L), the ordered list of prediction modes is not given. The ordered lists for those combinations can be “restored” by mapping the corresponding elements that are retained in the prediction table when those “restored” elements are needed for the prediction of a current block. Thus, in general, as long as an element in the prediction table can be obtained or restored from another element in the prediction table by way of mapping, the former can be eliminated. In other words, in a prediction table comprising a first group of elements and a second group of elements, wherein each of the second group of elements can be restored from a corresponding element in the first group by a mapping function, the second group of elements can be eliminated.

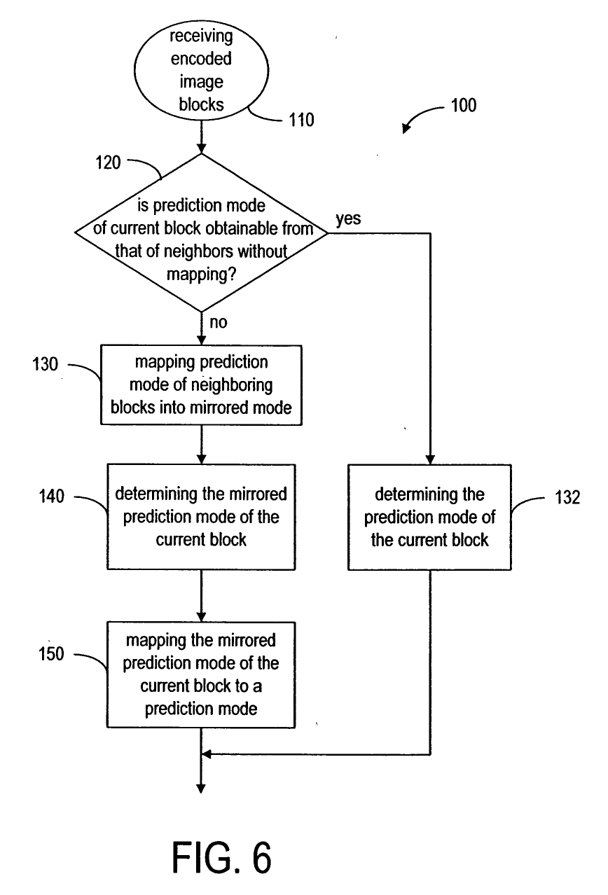

FIG. 6 is a flowchart illustrating the decoding stage when the symmetry in the prediction table is utilized. As shown, the method 100 comprises receiving a plurality of image blocks at step 110. When a current block is processed, it is determined at step 120 whether the prediction mode for the current block can be obtained from the prediction mode for the neighboring blocks without mapping. If so, then the spatial prediction mode of the current block is determined based on the prediction mode of the neighboring blocks at step 132. Otherwise, a complementary prediction mode of the neighboring blocks is provided at step 130, and a complementary prediction mode of the current block is determined based on the complementary prediction mode of the neighboring blocks at step 140. At step 150, the complementary prediction mode of the current block is mapped into the prediction mode of the current block.

Alternatively, it is possible to assign the same label to different prediction modes (grouping them together) of blocks U and L before using them to specify the prediction mode for block C. For example, in the case of the JVT coder, modes 1, 5 and 6 can be grouped together and labeled as 1, and modes 2, 7 and 8 can be grouped together and labeled as 2. As can be seen from FIG. 1, the directions of modes 7 and 8 are close to the direction of mode 2, and the directions of modes 5 and 6 are close to the direction of mode 1. After this grouping, each of blocks U and L can have one of the 5 modes labeled as 0, 1, 2, 3 and 4. Therefore, instead of 9×9 possible combinations of prediction modes of U and L, there are only 5×5 such combinations. Accordingly, the memory required to specify ordering of prediction modes for block C, given prediction modes of blocks U and L, will be 5×5×9 bytes, instead of 9×9×9 bytes (assuming that 1 byte of memory is required to hold 1 number). Furthermore, if the mapping function ƒ is used for “flipping” the ordered lists, the prediction table can be further simplified.

An example of the table specifying prediction mode as a function of ordering signaled in the bitstream when both of these methods are used in conjunction is given in TABLE IV.

TABLE IV

| | | | | | | |
|---|---|---|---|---|---|---|
| L/U | outside | 0 | 1 | 2 | 3 | 4 |
| Outside | -------- | 0-------- | 01------- | 10------- | --------- | --------- |
| 0 | 02------- | 024167835 | 150642387 | 024781635 | 013245867 | 012465738 |
| 1 | --------- | | 156043278 | 021468375 | 153046827 | 140652378 |
| 2 | 20------- | | 214806357 | | 283407156 | 247081635 |
| 3 | --------- | | | | 385240167 | 413205876 |
| 4 | --------- | | | | | 420671835 |

Moreover, it is also possible to limit the number of prediction modes for block C given prediction modes of blocks U and L. In the case of the JVT coder, there would still be 9×9possible combination of prediction modes of U and L. But to each of these combinations only m modes would be assigned, where m is smaller than 9. Accordingly, the number of the probable prediction modes is reduced to (9×9×m)<(9×9×9). Similarly, if the mapping function ƒ is used for “flipping” the ordered lists, the prediction table can be further simplified.

These methods can be used jointly or separately.

The primary objective of the present invention is to reduce the prediction table for spatial mode prediction in an image coding system. This objective can be achieved in many different ways, one of which is mode pair training, where two mode pairs are trained together where mapping results in different mode pairs. In other words, if mapping the elements of a mode pair to be trained would result in a different mode pair, the training for such mode pair and the mapped mode pair is targeted to the same element of Table III or Table IV. This kind of training eliminates almost half of the elements in the prediction table to be used by a decoder to determine the probable prediction modes of a current block based on the neighboring blocks, since some elements are not trained at all. Using the mirroring approach, the eliminated elements in the prediction table can be “restored” by mirroring the corresponding elements that are retained in the prediction table when those “restored” elements are needed for the prediction of a current block. Thus, in general, so long as an element in the prediction table can be obtained or restored from another element in the prediction table by way of mapping, the former can be eliminated. In other words, in a prediction table comprising a first group of elements and a second group of elements, wherein each of the second group of elements can be restored from a corresponding element in the first group by a mapping function, the second group of elements can be eliminated.

Thus, one of the methods of generation a prediction table for use in the encoding and decoding of an image can be carried out by the following steps:

arranging the elements in the prediction table into a first group of elements and a second group of elements, such that each of the elements in the second group can be determined from a corresponding element in the first group by way of mapping;

providing the first group of elements to a decoder for decoding the image or to an encoder for encoding an image;

mapping the spatial prediction modes for providing mirrored prediction modes when needed so as to allow a mirrored spatial prediction mode ƒ(p) of the current block to be determined based on the mirrored prediction mode of at least one neighboring block of the current block; and

mapping the mirrored prediction mode of the current block for obtaining the spatial prediction mode of the current block, or p=ƒ(ƒ(p)).

The above described method is provided only as a crude way of obtaining a reduced prediction table, and it is preferable to use some kind of training wherein the symmetry is taken into account already in the formation of the table elements.

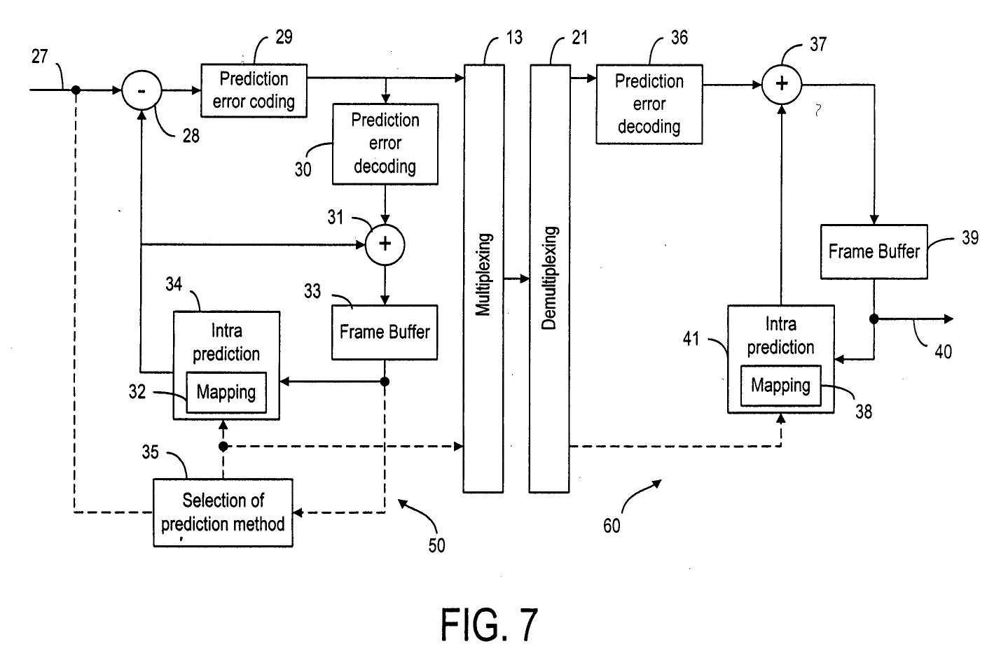

The spatial, prediction-based intra-coding, according to present invention, can be readily incorporated into a digital, image-block transfer system, as shown in FIG. 7. Assuming that a frame is to be encoded in intra format using some form of intra prediction, encoding of the frame proceeds as follows. The blocks of the frame to be coded are directed one by one to the encoder 50 of the video transfer system presented in FIG. 7. The blocks of the frame are received from a digital image source, e.g. a camera or a video recorder (not shown) at an input 27 of the image transfer system. In a manner known as such, the blocks received from the digital image source comprise image pixel values. The frame can be stored temporarily in a frame memory (not shown), or alternatively, the encoder receives the input data directly block by block.

The blocks are directed one by one to a prediction method selection block 35 that determines whether the pixel values of the current block to be encoded can be predicted on the basis of previously intra-coded blocks within the same frame or segment. In order to do this, the prediction method selection block 35 receives input from a frame buffer of the encoder 33, which contains a record of previously encoded and subsequently decoded and reconstructed intra blocks. In this way, the prediction method selection block can determine whether prediction of the current block can be performed on the basis of previously decoded and reconstructed blocks. Furthermore, if appropriate decoded blocks are available, the prediction method selection block 35 can select the most appropriate method for predicting the pixel values of the current block, if more than one such method may be chosen. It should be appreciated that in certain cases, prediction of the current block is not possible because appropriate blocks for use in prediction are not available in the frame buffer 33. In the situation where more than one prediction method is available, information about the chosen prediction method is supplied to multiplexer 13 for further transmission to the decoder. It should also be noted that in some prediction methods, certain parameters necessary to perform the prediction are transmitted to the decoder. This is, of course, dependent on the exact implementation adopted and in no way limits the application of the block boundary filter according to the invention.

Pixel values of the current block are predicted in the intra prediction block 34. The intra prediction block 34 receives input concerning the chosen prediction method from the prediction method selection block 35 and information concerning the blocks available for use in prediction from frame buffer 33. On the basis of this information, the intra prediction block 34 constructs a prediction for the current block. The predicted pixel values for the current block are sent to a differential summer 28 which produces a prediction error block by taking the difference between the pixel values of the predicted current block and the actual pixel values of the current block received from input 27. Next, the error information for the predicted block is encoded in the prediction error coding block in an efficient form for transmission, for example using a discrete cosine transform (DCT). The encoded prediction error block is sent to multiplexer 13 for further transmission to the decoder. The encoder of the digital image transmission system also includes decoding functionality. The encoded prediction error of the current block is decoded in prediction error decoding block 30 and is subsequently summed in summer 31 with the predicted pixel values for the current block. In this way, a decoded version of the current block is obtained. The decoded current block is then directed to the frame buffer 33.

Here, it is also assumed that the receiver receives the blocks that form a digital image frame one by one from a transmission channel.

In the receiver, 60, a demultiplexer receives the demultiplexed coded prediction error blocks and prediction information transmitted from the encoder 50. Depending on the prediction method in question, the prediction information may include parameters used in the prediction process. It should be appreciated that in the case that only one intra prediction method is used, information concerning the prediction method used to code the blocks is unnecessary, although it may still be necessary to transmit parameters used in the prediction process. In FIG. 7, dotted lines are used to represent the optional transmission and reception of prediction method information and/or prediction parameters. Assuming more than one intra prediction method may be used, information concerning the choice of prediction method for the current block being decoded is provided to intra prediction block 41. Intra prediction block 41 examines the contents of frame buffer 39 to determine if there exist previously decoded blocks to be used in the prediction of the pixel values of the current block. If such image blocks exist, intra prediction block 41 predicts the contents of the current block using the prediction method indicated by the received prediction method information and possible prediction-related parameters received from the encoder. Prediction error information associated with the current block is received by prediction error decoding block 36, which decodes the prediction error block using an appropriate method. For example, if the prediction error information was encoded using a discrete cosine transform, the prediction error decoding block performs an inverse DCT to retrieve the error information. The prediction error information is then summed with the prediction for the current image block in summer 37 and the output of the summer is applied to the frame buffer 39. Furthermore, as each block is decoded, it is directed to the output of the decoder 40, for example, to be displayed on some form of display means. Alternatively, the image frame may be displayed only after the whole frame has been decoded and accumulated in the frame buffer 39.

It should be noted that the intra-prediction block 34 constructs a prediction of the current block based on the previously encoded and subsequently decoded and reconstructed intra blocks as provided by the frame buffer 33. In particular, the prediction of the current block is determined from the spatial prediction modes of the previously reconstructed intra blocks using a prediction table, as shown in TABLE III or TABLE IV (not shown in FIG. 7). However, when the ordered list for the prediction modes (i,j) of the previously reconstructed intra blocks are missing from the prediction table, a mapping block 32 can be used to map the spatial prediction modes of the previously reconstructed blocks into complementary or mirrored spatial prediction modes (k,l). At this point, the intra prediction block 34 can determine the complementary or mirrored prediction mode ƒ(p) for the current block. Again the mapping block 32 is used to obtained the prediction mode p of the current block by mapping the complementary prediction mode ƒ(p). Likewise, a mapping block 38 is used for mapping when needed.

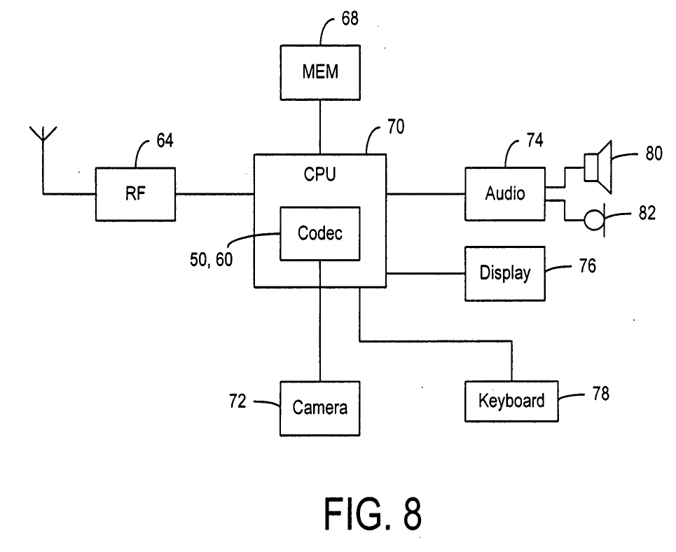

The mapping algorithm, which is used to perform the mapping of (i,j) to (k,l) and the mapping of ƒ(p) top, can be coded in a software program, which comprises machine executable steps for performing the method according to the present invention. Advantageously, the software program is stored in a storage medium. For example, the software program is stored in a memory unit resident in a CPU 70, or in a separate memory unit 68, as shown in FIG. 8. FIG. 8 presents a simplified schematic diagram of a mobile terminal 90 intended for use as a portable video telecommunications device, incorporating the prediction mode mapping method of the present invention. The mobile terminal 90 comprises at least a display module 76 for displaying images, an image capturing device 72, and an audio module 74 for capturing audio information from an audio input device 82 and reproducing audio information on an audio producing device 80. Advantageously, the mobile terminal 90 further comprises a keyboard 78 for inputting data and commands, a radio frequency component 64 for communicating with a mobile telecommunications network and a signal/data processing unit 70 for controlling the operation of the telecommunications device. Preferably, the digital image block transfer system (50, 60) is implemented within in the processor 70.

Thus, although the invention has been described with respect to a preferred embodiment thereof, it will be understood by those skilled in the art that the foregoing and various other changes, omissions and deviations in the form and detail thereof may be made without departing from the scope of this invention.

1-23. (canceled)

24. A method of encoding a digital image using spatial prediction, the digital image comprising a plurality of image blocks including a current image block, the method comprising obtaining an ordered list of available spatial prediction modes for spatial prediction of the current image block in dependence upon a combination of a first spatial prediction mode used to predict a first neighboring image block of the current image block and a second spatial prediction mode used to predict a second neighboring image block of the current image block, wherein for a certain predetermined combination of first and second spatial prediction modes for respective first and second neighboring image blocks, the corresponding ordered list of available spatial prediction modes for the current image block is obtained from an ordered list of spatial prediction modes corresponding to a different combination of first and second spatial prediction modes for said respective first and second neighboring image blocks, thereby reducing an amount of information required to represent the ordering of spatial prediction modes.

25. A method according to claim 24, wherein the available spatial prediction modes are arranged in the ordered list according to a probability of their use in spatial prediction of the current image block.

26. A method according to claim 24, wherein each of the available spatial prediction modes has a corresponding mode number and the available spatial prediction modes are arranged in the ordered list according to their respective mode numbers.

27. A method according to claim 24, wherein the ordered list provides an indication of a rank associated with each available spatial prediction mode, the rank of a given one of the available spatial prediction modes providing an indication of a probability of its use in spatial prediction of the current image block.

28. A method according to claim 24, comprising obtaining an ordered list of available spatial prediction modes corresponding to a first predetermined combination of first and second spatial prediction modes for respective first and second neighboring image blocks from an ordered list of available spatial prediction modes corresponding to a second predetermined combination of first and second spatial prediction modes for said respective first and second neighboring image blocks by applying a mapping function.

29. A method according to claim 28, wherein the mapping function exploits symmetry in ordered lists of spatial prediction modes corresponding to different combinations of first and second spatial prediction modes for the respective first and second neighboring image blocks.

30. A method according to claim 24, comprising applying a mirroring operation about a line of symmetry defined with respect to the first and second neighboring image blocks to associate particular ones of the available spatial prediction modes with particular other ones of the available spatial prediction modes.

31. A method according to claim 24, wherein the first neighboring image block is an image block adjoining the left boundary of the current image block and the second neighboring image block is an image block adjoining the upper boundary of the current image block.

32. A method according to claim 24, wherein the available spatial prediction modes include spatial prediction modes with predetermined prediction directions.

33. A method according to claim 32, comprising obtaining an ordered list of available spatial prediction modes corresponding to a first predetermined combination of first and second spatial prediction modes for respective first and second neighboring image blocks from an ordered list of available spatial prediction modes corresponding to a second predetermined combination of first and second spatial prediction modes for said respective first and second neighboring image blocks by applying a mirroring operation about a line of symmetry defined with respect to the first and second neighboring image blocks, the mirroring operation relating a particular one of the available spatial prediction modes having a particular first prediction direction to another one of the available spatial prediction modes having a second prediction direction, said second prediction direction mapping onto the first prediction direction when mirrored about said line of symmetry.

34. A method according to claim 32, further comprising grouping together available spatial prediction modes with similar prediction directions.

35. A method according to claim 24, further comprising selecting a spatial prediction mode for spatial prediction of the current image block from the obtained ordered list of available spatial prediction modes.

36. A method according to claim 35, further comprising transmitting information about the selected spatial prediction mode to a corresponding decoder.

37. An image encoder for encoding a digital image using spatial prediction, the digital image comprising a plurality of image blocks including a current image block, the image encoder arranged to obtain an ordered list of available spatial prediction modes for spatial prediction of the current image block in dependence upon a combination of a first spatial prediction mode used to predict a first neighboring image block of the current image block and a second spatial prediction mode used to predict a second neighboring image block of the current image block, wherein for a certain predetermined combination of first and second spatial prediction modes for respective first and second neighboring image blocks, the image encoder is arranged to obtain a corresponding ordered list of available spatial prediction modes for the current image block from an ordered list of spatial prediction modes corresponding to a different combination of first and second spatial prediction modes for said respective first and second neighboring image blocks, thereby reducing an amount of information required to represent the ordering of spatial prediction modes.

38. An image encoder according to claim 37, wherein the available spatial prediction modes are arranged in the ordered list according to a probability of their use in spatial prediction of the current image block.

39. An image encoder according to claim 37, wherein each of the available spatial prediction modes has a corresponding mode number and the available spatial prediction modes are arranged in the ordered list according to their respective mode numbers.

40. An image encoder according to claim 37, wherein the ordered list provides an indication of a rank associated with each available spatial prediction mode, the rank of a given one of the available spatial prediction modes providing an indication of a probability of its use in spatial prediction of the current image block.

41. An image encoder according to claim 37, arranged to obtain an ordered list of available spatial prediction modes corresponding to a first predetermined combination of first and second spatial prediction modes for respective first and second neighboring image blocks from an ordered list of available spatial prediction modes corresponding to a second predetermined combination of first and second spatial prediction modes for said respective first and second neighboring image blocks by applying a mapping function.

42. An image encoder according to claim 41, arranged to apply a mapping function that exploits symmetry in ordered lists of spatial prediction modes corresponding to different combinations of first and second spatial prediction modes for the respective first and second neighboring image blocks.

43. An image encoder according to claim 37, arranged to apply a mirroring operation about a line of symmetry defined with respect to the first and second neighboring image blocks to associate particular ones of the available spatial prediction modes with particular other ones of the available spatial prediction modes.

44. An image encoder according to claim 37, wherein the first neighboring image block is an image block adjoining the left boundary of the current image block and the second neighboring image block is an image block adjoining the upper boundary of the current image block.

45. An image encoder according to claim 37, wherein the available spatial prediction modes include spatial prediction modes with predetermined prediction directions.

46. An image encoder according to claim 45, arranged to obtain an ordered list of available spatial prediction modes corresponding to a first predetermined combination of first and second spatial prediction modes for respective first and second neighboring image blocks from an ordered list of available spatial prediction modes corresponding to a second predetermined combination of first and second spatial prediction modes for said respective first and second neighboring image blocks by applying a mirroring operation about a line of symmetry defined with respect to the first and second neighboring image blocks, the mirroring operation relating a particular one of the available spatial prediction modes having a particular first prediction direction to another one of the available spatial prediction modes having a second prediction direction, said second prediction direction mapping onto the first prediction direction when mirrored about said line of symmetry.

47. An image encoder according to claim 45, further arranged to group together available spatial prediction modes with similar prediction directions.

48. An image encoder according to claim 37, further arranged to select a spatial prediction mode for spatial prediction of the current image block from the obtained ordered list of available spatial prediction modes.

49. An image encoder according to claim 48, further arranged to transmit information about the selected spatial prediction mode to a corresponding decoder.

50. A video encoder comprising an image encoder according to claim 37.

51. A digital image transfer system comprising an image encoder according to claim 37.

52. A portable video telecommunications device comprising an image encoder according to claim 37.

53. A method of decoding a digital image using spatial prediction, the digital image comprising a plurality of image blocks including a current image block, the method comprising obtaining an ordered list of available spatial prediction modes for spatial prediction of the current image block in dependence upon a combination of a first spatial prediction mode used to predict a first neighboring image block of the current image block and a second spatial prediction mode used to predict a second neighboring block of the current image block, wherein for a certain predetermined combination of first and second spatial prediction modes for respective first and second neighboring image blocks, the corresponding ordered list of available spatial prediction modes for the current image block is obtained from an ordered list of spatial prediction modes corresponding to a different combination of first and second spatial prediction modes for said respective first and second neighboring image blocks, thereby reducing an amount of information required to represent the ordering of spatial prediction modes.

54. A method according to claim 53, wherein the available spatial prediction modes are arranged in the ordered list according to a probability of their use in spatial prediction of the current image block.

55. A method according to claim 53, wherein each of the available spatial prediction modes has a corresponding mode number and the available spatial prediction modes are arranged in the ordered list according to their respective mode numbers.

56. A method according to claim 53, wherein the ordered list provides an indication of a rank associated with each available spatial prediction mode, the rank of a given one of the available spatial prediction modes providing an indication of a probability of its use in spatial prediction of the current image block.

57. A method according to claim 53, comprising obtaining an ordered list of available spatial prediction modes corresponding to a first predetermined combination of first and second spatial prediction modes for respective first and second neighboring image blocks from an ordered list of available spatial prediction modes corresponding to a second predetermined combination of first and second spatial prediction modes for said respective first and second neighboring image blocks by applying a mapping function.

58. A method according to claim 57, wherein the mapping function exploits symmetry in ordered lists of spatial prediction modes corresponding to different combinations of first and second spatial prediction modes for the respective first and second neighboring image blocks.

59. A method according to claim 53, comprising applying a mirroring operation about a line of symmetry defined with respect to the first and second neighboring image blocks to associate particular ones of the available spatial prediction modes with particular other ones of the available spatial prediction modes.

60. A method according to claim 53, wherein the first neighboring image block is an image block adjoining the left boundary of the current image block and the second neighboring image block is an image block adjoining the upper boundary of the current image block.

61. A method according to claim 53, wherein the available spatial prediction modes include spatial prediction modes with predetermined prediction directions.

62. A method according to claim 61, comprising obtaining an ordered list of available spatial prediction modes corresponding to a first predetermined combination of first and second spatial prediction modes for respective first and second neighboring image blocks from an ordered list of available spatial prediction modes corresponding to a second predetermined combination of first and second spatial prediction modes for said respective first and second neighboring image blocks by applying a mirroring operation about a line of symmetry defined with respect to the first and second neighboring image blocks, the mirroring operation relating a particular one of the available spatial prediction modes having a particular first prediction direction to another one of the available spatial prediction modes having a second prediction direction, said second prediction direction mapping onto the first prediction direction when mirrored about said line of symmetry.

63. A method according to claim 61, further comprising grouping together available spatial prediction modes with similar prediction directions.

64. A method according to claim 53, further comprising selecting a spatial prediction mode for spatial prediction of the current image block from the obtained ordered list of available spatial prediction modes.

65. A method according to claim 53, further comprising receiving information relating to a selected spatial prediction mode from a corresponding encoder.

66. An image decoder for decoding a digital image using spatial prediction, the digital image comprising a plurality of image blocks including a current image block, the image decoder arranged to obtain an ordered list of available spatial prediction modes for spatial prediction of the current image block in dependence upon a combination of a first spatial prediction mode used to predict a first neighboring image block of the current image block and a second spatial prediction mode used to predict a second neighboring block of the current image block, wherein for a certain predetermined combination of first and second spatial prediction modes for respective first and second neighboring image blocks, the image decoder is arranged to obtain a corresponding ordered list of available spatial prediction modes for the current image block from an ordered list of spatial prediction modes corresponding to a different combination of first and second spatial prediction modes for said respective first and second neighboring image blocks, thereby reducing an amount of information required to represent the ordering of spatial prediction modes.

67. An image decoder according to claim 66, wherein the available spatial prediction modes are arranged in the ordered list according to a probability of their use in spatial prediction of the current image block.

68. An image decoder according to claim 66, wherein each of the available spatial prediction modes has a corresponding mode number and the available spatial prediction modes are arranged in the ordered list according to their respective mode numbers.

69. An image decoder according to claim 66, wherein the ordered list provides an indication of a rank associated with each available spatial prediction mode, the rank of a given one of the available spatial prediction modes providing an indication of a probability of its use in spatial prediction of the current image block.

70. An image decoder according to claim 66, arranged to obtain an ordered list of available spatial prediction modes corresponding to a first predetermined combination of first and second spatial prediction modes for respective first and second neighboring image blocks from an ordered list of available spatial prediction modes corresponding to a second predetermined combination of first and second spatial prediction modes for said respective first and second neighboring image blocks by applying a mapping function.

71. An image decoder according to claim 70, arranged to apply a mapping function that exploits symmetry in ordered lists of spatial prediction modes corresponding to different combinations of first and second spatial prediction modes for the respective first and second neighboring image blocks.

72. An image decoder according to claim 66, arranged to apply a mirroring operation about a line of symmetry defined with respect to the first and second neighboring image blocks to associate particular ones of the available spatial prediction modes with particular other ones of the available spatial prediction modes.

73. An image decoder according to claim 66, wherein the first neighboring image block is an image block adjoining the left boundary of the current image block and the second neighboring image block is an image block adjoining the upper boundary of the current image block.

74. An image decoder according to claim 66, wherein the available spatial prediction modes include spatial prediction modes with predetermined prediction directions.

75. An image decoder according to claim 74, arranged to obtain an ordered list of available spatial prediction modes corresponding to a first predetermined combination of first and second spatial prediction modes for respective first and second neighboring image blocks from an ordered list of available spatial prediction modes corresponding to a second predetermined combination of first and second spatial prediction modes for said respective first and second neighboring image blocks by applying a mirroring operation about a line of symmetry defined with respect to the first and second neighboring image blocks, the mirroring operation relating a particular one of the available spatial prediction modes having a particular first prediction direction to another one of the available spatial prediction modes having a second prediction direction, said second prediction direction mapping onto the first prediction direction when mirrored about said line of symmetry.

76. An image decoder according to claim 74, further arranged to group together available spatial prediction modes with similar prediction directions.

77. An image decoder according to claim 66, further arranged to select a spatial prediction mode for spatial prediction of the current image block from the obtained ordered list of available spatial prediction modes.

78. An image decoder according to claim 66, further arranged to receive information relating to a selected spatial prediction mode from a corresponding encoder.

79. A video decoder comprising an image decoder according to claim 66.

80. A video encoder comprising an image decoder according to claim 66.

81. A digital image transfer system comprising an image decoder according to claim 66.

82. A portable video telecommunications device comprising an image decoder according to claim 66.

83. A software application product embedded in a computer readable medium, said product having executable codes for performing the method according to claim 24.

84. A software application product embedded in a computer readable medium, said product having executable codes for performing the method according to claim 53.
